(19) United States
(12) Patent Application Publication
(10) Pub. No.: US 2007/0201440 A1
(43) Pub. Date: Aug. 30, 2007

(54) IMPROVED VOIC-OVER-INTERNET-PROTOCOL METHOD

(75) Inventors: SAMRAT GANGULY, MONMOUTH JUNCTION, NJ (US); DRAGOS NICULESCU, HIGHLAND PARK, NJ (US); KYUNG TAE KIM, WEST WINDSOR, NJ (US); RAUF IZMAILOV, PLAINSBORO, NJ (US)

Correspondence Address: BROSEMER, KOLEFAS & ASSOCIATES, LLC, ONE BETHANY ROAD, BUILDING 4 - SUITE #58, HAZLET, NJ, 07730, US

(73) Assignee: NEC LABORATORIES AMERICA, INC., PRINCETON, NJ (US)

(21) Appl. No.: 11/307,948

(22) Filed: Feb. 28, 2006

(51) Int. Cl. H04L 12/66

(52) U.S. Cl. 370/356

(57) ABSTRACT

A method of transporting Voice-Over-Internet-Protocol Packets in a wireless mesh network wherein VoIP packets from independent call flows are aggregated prior to transmission over multiple hops of the wireless network. Significant performance improvements are realized including the number of simultaneous VoIP calls supported and overall Quality-of-Service (QoS) for the individual calls.

### FIELD OF THE INVENTION

This invention relates generally to the field telecommunications and in particular to an improved method of providing voice services on wireless networks employing Internet Protocols (VoIP).

### BACKGROUND OF THE INVENTION

With Internet Protocol telephony proving it reliability and cost-effectiveness in wired networks, enterprises are considering how to extend those benefits by enabling IP voice over wireless networks. One problem with this extension is that typical local area networks (LAN), and in particular wireless LANs (WLAN), were not intended or designed to handle IP voice traffic. Solving the issues at the core of this problem is the key to unlocking the true value of wireless VoIP.

As anyone who has used a wireless LAN will recognize, typical WLANs offer highly variable data rates and quality of service (QoS). Actual bandwidth and connection quality may depend on a user's distance from an access point (AP), the number of other users connected to the same AP, the bandwidth demands of each user, and the amount of interference from other sources. Given these variables and the overhead associated with packet communication, WLAN throughput can vary from a maximum of about one-half the specified capacity (5.5 Mbps out of 11 Mbps on an 802.11b network, for example) down to a fraction of it (1 Mbps or less on an 802.11b network). Unfortunately, IP voice devices cannot operate without basic guarantees of low delays, low jitter, and extremely low packet loss. As those skilled in the art can appreciate, ensuring those capabilities even on wired networks requires some adjustment to QoS mechanisms. Replacing the wires with wireless RF channels only adds an additional level of difficulty.

A further emerging characteristic of WLANs is their mesh topology, which provides significant advantages over centralized topologies (i.e., star) which unfortunately exhibit strong potential for bottlenecks, resulting latencies and single point of failure.

Advantageously, wireless mesh networks distribute intelligence from central switches to distributed nodes or access points. Consequently, such wireless mesh networks permit the nodes or access points to communicate with other nodes, without being routed through a central switch point thereby eliminating a centralized failure point and providing self-healing and self-organization. And although traffic decisions may be made locally, wireless mesh networks may advantageously be managed globally.

For wireless networks to intercommunicate in such a mesh topology, the nodes typically include self-discovery features which permit the determination of whether a particular node serves as an access point, a backbone for traffic coming/going to other nodes, or a combination of roles.

Accordingly, a characteristic of VoIP wireless mesh networks is that VoIP packets must traverse multiple nodes thereby requiring multiple hops from a source to a destination. As is known, the QoS deteriorates dramatically along with the number of independent VoIP calls that may be supported over multiple-hop path(s) as the number of hops increases. In fact, simple tests performed on a 14-node network indicate that the number of VoIP calls decreases from 6 to 1 as the number of hops is increased from 1 to 5.

Contributing to this performance deterioration is the relatively small size (32 bytes) of the packets used for streaming VoIP calls. As can be appreciated, this small packet size results in more overhead/transmission, more contention in accessing channels, more self-interference and a plethora of problems as well.

Prior art attempts at enhancing the performance of wireless VoIP networks included packet aggregation over a single hop (See, e.g., G. Lebizay, et al, “Method for Sending Multiple Voice channels Over Packet Networks”, United States Published Patent Application Number US 2003/0093550 A1, May 15, 2003; and W. Wang et al, “A Multiples-Multicast Scheme That Improves System Capacity of Voice-Over-IP on Wireless LAN by 100%”, IEEE ISCC'04, Alexandria, Egypt, June 2004). Such prior art schemes however, fail to provide the level of performance necessary for emerging, multi-hop wireless mesh VoIP networks.

### SUMMARY OF THE INVENTION

We have developed, in accordance with the principles of the invention, a Voice-Over-Internet-Protocol method that improves the overall quality of service while permitting a greater number of independent VoIP calls in a wireless mesh VoIP network.

More specifically, and in sharp contrast to the prior art which provided packet-level aggregation over a single hop, our inventive method is based on stream-level aggregation over multiple hops—thereby eliminating a number of infirmities associated with the prior art.

According to our inventive method, a wireless mesh network is analyzed for nodes at which multiple call flows (streams) converge. Packets which are part of the flows are then aggregated and transported over multiple-hops within the network. At a nodal point at which the streams naturally diverge, the packets are de-aggregated and subsequently further transported/delivered to their destination.

Advantageously, our inventive aggregation method works with numerous wireless protocols and routing methodologies.

### BRIEF DESCRIPTION OF THE DRAWING

A more complete understanding of the present invention may be realized by reference to the accompanying drawing in which:

FIG. 1 is a schematic of a PRIOR ART packet-level, single-hop aggregation scheme;

FIG. 2 is a schematic of a flow-based, multi-hop aggregation according to the teachings of the present invention; and

FIG. 3 is a schematic of a wireless mesh network exemplifying numerous principles of the present invention;

FIG. 4 is a flow chart showing the high-level steps of the method of the present invention; and

FIG. 5 is a schematic of a representative VoIP Frame used in conjunction with the method of the present invention.

### DETAILED DESCRIPTION

As noted earlier, one aspect of the present invention is to increase the number of Voice-over-Internet Protocol (VoIP) calls that can be supported in a given multi-hop wireless mesh network. Before we fully describe our inventive method however, it is first useful to describe the single-hop scenario of the prior art as an introduction to the terminology and shortcoming(s) of the prior-art.

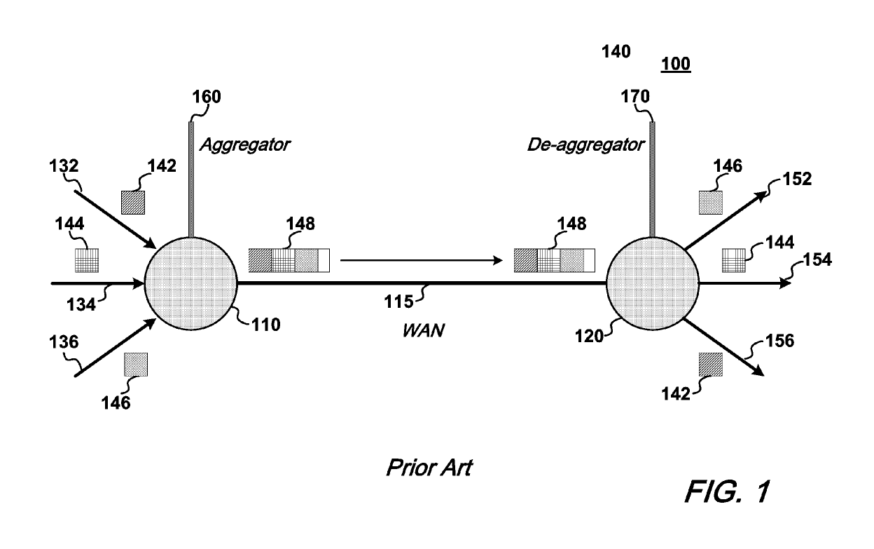

FIG. 1 shows a schematic of a prior art, single hop wireless network transporting VoIP protocol(s). More particularly, shown in that FIG. 1 are two wireless nodes 110, 120, which may be wireless access points (AP) or wireless routers. The two nodes 110, 120 which are part of a larger wireless network are shown directly connected by one-hop wireless link 115 which may be any of a number of wireless protocols, including 802.11 g.

As shown in FIG. 1, node 110 receives a number of individual data streams 132, 134, 136 from a number of VoIP data sources (not specifically shown) which provide VoIP data 142, 144, and 146, respectively. As can be appreciated, because of the relatively small size of VoIP data packets 142, 144, and 146 if they were transmitted individually over link 115 it would represent a quite inefficient use of the link and service degradation would result when a significant number of separate sources providing VoiP data simultaneously.

Accordingly, the VoIP data packets 142, 144, and 146 are aggregated into aggregate packet 148 through the effect of data aggregator 160. This aggregate packet 148 is transmitted over wireless link 115 to an adjacent node 120 where it is de-aggregated through the effect of de-aggregator 170 into a number of separate component VoIP packets 142, 144 and 146 for subsequent conveyance to VoIP data recipients (not specifically shown) via individual data streams 152, 154 and 156 respectively.

While this simple methodology is useful for the single-hop scenario such as that shown in FIG. 1, it fails in multi-hop environments. More specifically, and as noted prior, in order to support Quality of Service (QoS) metrics for voice calls, each packet must meet a strict delay budget. As aggregation requires the buffering of packets, performing such aggregation at each node would add significant delay over a multi-hop path.

In addition, carrying voice calls over a multi-hop mesh network may create a skewed load distribution where aggregation is not feasible or otherwise possible due to insufficient call volume at a given time to aggregate. Finally—and as we shall show—the effective routing in multiple-hop networks provides numerous opportunity for aggregation.

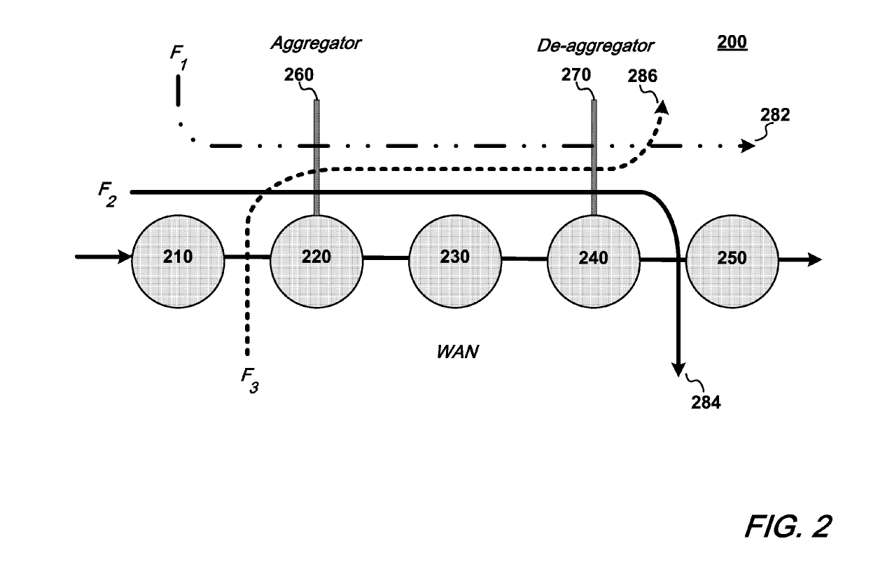

FIG. 2 is a schematic of a multiple node wireless network which we shall now reference to outline our inventive method. More specifically, shown in FIG. 2 is a five (5) node network which—for the sake of simplicity—is shown linearly. Advantageously, our inventive method works with a virtually any multi-hop wireless network topology and is not limited to the simple linear multi-hop shown in FIG. 2.

As can be seen in FIG. 2, the five nodes 210, 220, 230, 240, and 250 are shown connected by a single wireless link from one to the next. Shown further in that FIG. 2 are three flows F₁, F₂ and F₃ indicated by 282, 284, and 286, respectively. By inspection, it can be observed that the three flows F₁, F₂ and F₃ share a common path between nodes 220, 230, and 240. Consequently, the VoIP packets that comprise these three flows F₁, F₂ and F₃ may be aggregated through the effect of aggregator 260 and subsequently de-aggregated through the effect of de-aggregator 270.

Once aggregated through the effect of aggregator 260, the aggregated packets comprising the three flows F₁, F₂ and F₃ may be transmitted from node 220, through node 230, to node 240. Since the individual VoiP packets from the three flows are aggregated, the wireless link(s) over which they traverse is more efficient.

From this FIG. 1 a number of aspects of our inventive method emerge. In particular, our inventive aggregation method is based upon a flow based upon the flow path, and delay associated with each flow. For example the aggregation of the three flows F₁, F₂ and F₃ shown between node 220, to 240 is “cost effective”, while aggregation of F₁ from node 210 to node 220 is not as it would only add delay without any added performance benefit.

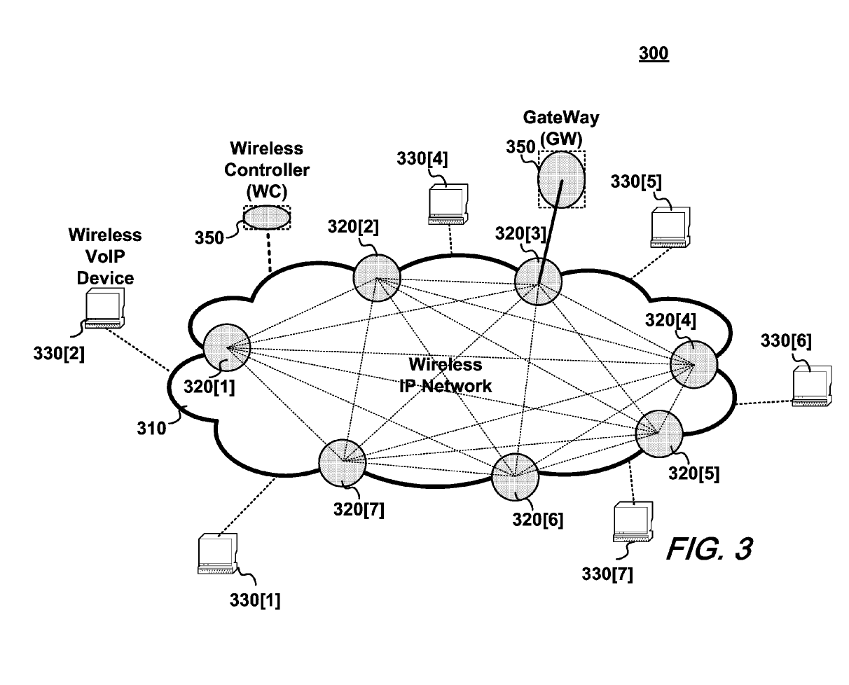

With this foundation in place, we may now turn to a multi-hop mesh network such as 300, shown in FIG. 3. In particular shown in FIG. 3 is a wireless mesh network 310 having a number of fully-interconnected nodes 320[1] . . . 320[7] and a number of Wireless VoIP devices 330[1] . . . 330[7] which provide sources and/or destination(s) for VoIP traffic traversing the network 310.

Shown further in this FIG. 3 is gateway 350 which—as is known—serves to interconnect multiple networks together (other networks not specifically shown). In addition, while the gateway is 350 is shown as a hardware device for simplicity, it is of course known by those skilled in the art that such a gateway 350 may be a hardware device, a software device or a combination thereof. Finally, wireless controller 340—as we shall see in detail later—determines locations (nodes) within the network 310 at which flow aggregation and de-aggregation should take place at a given time. Once such location(s) are identified, they are directed—through appropriate signaling—by the wireless controller 340 to either aggregate or de-aggregate as appropriate.

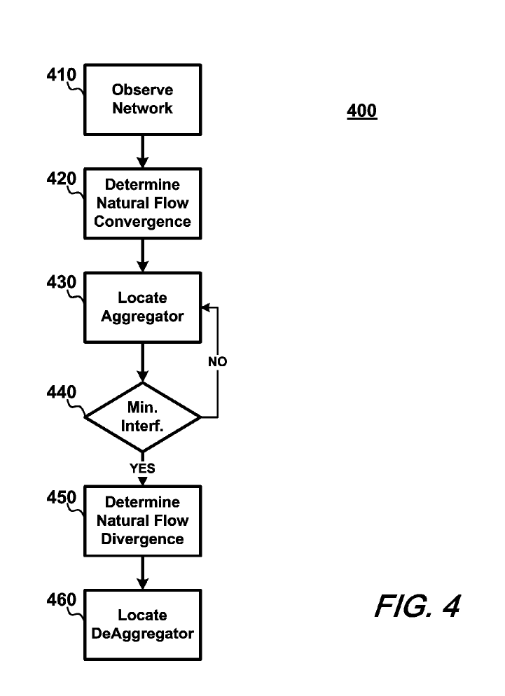

We may now discuss our inventive method with simultaneous reference to the multi-hop mesh network shown in FIG. 3 and the flowchart of FIG. 4. With reference to those figures, it can be appreciated that any or all of the VoIP devices 330[1] . . . 330[7] may be generating/receiving VoIP traffic at a given time. In addition any other devices with which a particular device is communicating may be either within or outside of the mesh network shown. In those cases where communication takes place with a device outside of the mesh network shown, traffic will be communicated via gateway device 350. As note prior, for those situations where streams of VoIP packet(s) traverse the network 300 via more than two nodes (i.e., 320[7]->320[2]->320[3]->GW) there exists the possibility for efficiency increases when different streams are aggregated into aggregated packets. Such aggregation is initiated through the effect of the wireless controller 350.

Operationally, the wireless controller 350 monitors/observes (Block 410) the network in search of flows or streams of VoIP packets and points (nodes) at which they naturally converge (Block 420). That is to say, common way-points or via nodes where independent streams converge. Such individual flows would be associated with, for example, an individual phone-to-phone conversation.

Once such potential common nodes (aggregator(s)) are identified, they are evaluated for interference characteristics. In wireless networks such as that shown in FIG. 3, interference is characterized by extraneous signals, i.e., a packets a node “hears” that it is not supposed to hear or otherwise garbled such that it (the node) cannot act upon it.

If the target aggregator indicated by the observed flow convergence also provides a minimum amount of interference, then that node is determined to be the aggregator for the converged flows. If not, then alternative nodes are considered where the flows converge and the interference is a more desirable level. (Blocks 440, 430)

Once the aggregator is determined, the network is examined for nodes at which the aggregated flows naturally diverge (Block 450). Such location(s) are determined to be de-aggregators (Block 460). Advantageously, our inventive method may work with existing routing methods that make efficient use of bandwidth and throughput in conjunction with the interference criteria discussed herein. Accordingly, those skilled in the art will quickly recognize that any of a variety of such bandwidth/throughput routing methodologies may be interoperable with out method.

As can be appreciated, our aggregation/de-aggregation preferably works in those multi-hop networks where individual streams traverse more than one hop between aggregation/de-aggretation. Generally speaking, the more hops that are aggregated, the greater the resulting network efficiencies. Still further, the efficiencies are realized without any significant loss of speech or voice quality.

Our inventive method advantageously realizes the improved performance characteristics because certain redundant characteristics in the aggregated packets are combined. More particularly, certain header elements may be combined.

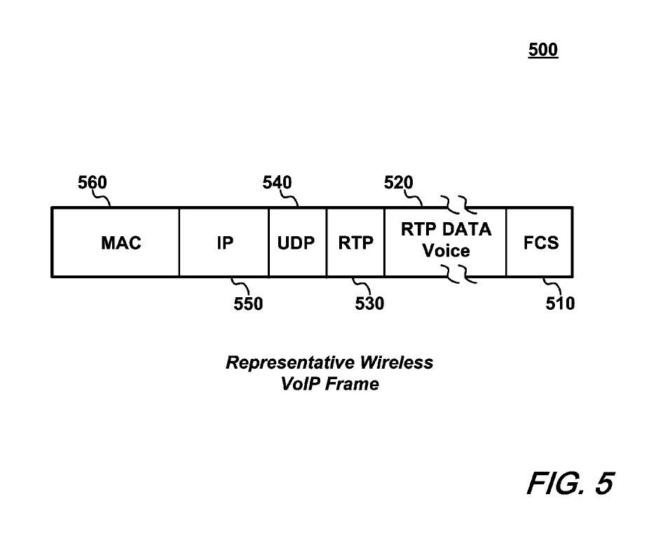

With reference to FIG. 5, there is shown a representative wireless frame, which may be used to transport VoIP data. In particular such packets/frame or cells 500 include a 20 byte IP header 550, an 8-byte UDP header 540, a 12-byte RTP header and the RTP data 520.

In a typical implementation, the RTP data is a 20-ms voice sample. For G.729, the data is 20 bytes, for G.7111 it is 160 bytes in length. The total VoIP packet is ˜200-bytes of (IP+UDP+RTP) headers plus the RTP data 520. Since an 802.11 header (Layer 2 MAC address 560) is 24 bytes long and the packet frame check sequence (FCS) 510 is 4 bytes long, the total packet size is ˜228 bytes.

According to our aggregating method, the IP, UDP and RTP headers are compressed from their nominal 40 bytes to at least 26 bytes. Advantageously, since the RTP data 520 is not compressed, its quality is not affected by our inventive method(s).

It should be appreciated by those skilled in the art that the benefits of our multi-hop aggregation method may be further enhanced by selective (appropriate) routing of flows. In order to fully realize these benefits, each flow is preferably routed such that the total number of packets (including aggregated packets) is minimized while end-to-end delay budget(s) is/are met.

Those skilled in the art will readily understand that a delay budget is determined from particular application requirements. For example, for a VoIP call of acceptable quality, the delay budget is approximately 170 ms. Accordingly, the routing algorithm employed should try and establish a path for a given flow which results in maximum sharing of multiple flows along a path segment. Maximum sharing is highly desirable with our inventive aggregation method, as it leads to a larger number of aggregated packets.

In a preferred embodiment, routing may be performed by adding certain auxiliary links. More particularly, if there exists a path segment say, (a->n1->n2->n3-> . . . ->b), in the mesh network along which aggregated packets flow wherein packets are aggregated at node “a” and deaggregated at node “b”, we will add an auxiliary link(s) in that path from a->b. This process is repeated for every such path segment(s) resulting in a new graph. A shortest-hop routing is performed on this new graph whereby which preferably uses the auxiliary link(s), while minimizing the number of total packets transported.

Advantageously, our method may employ such well known shortest hop algorithms such as Dijkstra's algorithm, wherein in each step of the Dijkstra algorithm, we perform a delay check from source to the current node in the algorithm to see whether the delay budget is exceeded. If it does, that node is not included in the path, or alternatively excluded.

At this point, while I have discussed and described my invention using some specific examples, those skilled in the art will recognize that my teachings are not so limited. Accordingly, my invention should be only limited by the scope of the claims attached hereto.

What is claimed is:

1. A method of transmitting Voice Over Internet Protocol (VoIP) packets in a wireless communications network, wherein said network comprises a plurality of nodes, each one of said nodes capable of receiving and retransmitting VoIP packets, said method comprising:
aggregating, through the effect of an aggregator, VoIP packets associated with two or more call flows, into an aggregate packet;
transporting, the aggregate packet in the network for a distance of at least two hops—wherein the distance between each adjacent node is one hop; and
de-aggregating, through the effect of a de-aggregator, the aggregate packet into its constituent VoIP packets for subsequent transmission.

2. The method of claim 1, further comprising the steps of:
monitoring the network; and
determining at which node(s) call flows naturally converge.

3. The method of claim 2 further comprising the steps of:
locating the aggregator at a node wherein said call flows naturally converge.

4. The method of claim 3 further comprising the steps of:
monitoring the network; and
determining at which node(s) the call flows so aggregated naturally diverge.

5. The method of claim 4 further comprising the steps of:
locating the de-aggreator at a node wherein said aggregated call flows naturally diverge.

6. The method of claim 1 wherein said aggregate packet has a maximum size associated with it and said transporting step comprises the steps of:
determining, at each node associated with said hops:
whether additional VoIP packets associated with particular call flows are to be further aggregated into said aggregate packet;
whether said further aggregated packet will exceed the maximum size;
further aggretating, the additional VoIP packets into the further aggregate packet such that the maximum size is not exceeded; and
forwarding, as appropriate, either the aggregate packet or the further aggregated packet to an appropriate node.

7. The method of claim 1 further comprising the steps of:
determining, an appropriate route for the aggregated packet from the aggregating node to the de-aggregating node.

8. The method of claim 7 wherein said appropriate route is determined according to the maximum size of the aggregate packet and the total number of packets in the network.

9. The method of claim 9 wherein the appropriate node to which the packet is forwarded is determined according to a shortest-hop methodology.
